(19) United States
(12) Patent Application Publication
(10) Pub. No.: US 2026/0195795 A1
(43) Pub. Date: Jul. 9, 2026

(54) DISTRIBUTION CONTROL SYSTEM, DISTRIBUTION CONTROL METHOD, AND NON-TRANSITORY COMPUTER-READABLE MEDIUM

(71) Applicant: NEC Corporation, Tokyo (JP)

(72) Inventors: Yosuke UMEDA, Tokyo (JP); Hiroka NAGASE, Tokyo (JP)

(73) Assignee: NEC Corporation, Tokyo (JP)

(21) Appl. No.: 19/428,595

(22) Filed: Dec. 22, 2025

(30) Foreign Application Priority Data
Jan. 7, 2025 (JP) 2025-002049

(51) Int. Cl. G06Q 30/0251; G02B 27/01

(52) U.S. Cl. CPC G06Q 30/0264; G02B 27/017; G06Q 30/0269; G02B 2027/0178

(57) ABSTRACT

An object is to provide a distribution control system capable of appropriately distributing an advertisement to a worker. A distribution control system according to the present disclosure includes a worker attribute acquisition unit for acquiring a worker attribute indicating a worker attribute, a work situation acquisition unit for acquiring a work situation of the worker, an advertisement determination unit for determining an advertisement to be distributed to the worker based on the worker attribute and the work situation, and a distribution control unit for controlling distribution of the advertisement.

### INCORPORATION BY REFERENCE

This application is based upon and claims the benefit of priority from Japanese patent application No. 2025-002049, filed on January 7, 2025, the disclosure of which is incorporated herein in its entirety by reference.

### TECHNICAL FIELD

The present disclosure relates to a distribution control system, a distribution control method, and a non-transitory computer-readable medium.

### BACKGROUND ART

A technique for distributing an advertisement to a worker who works in a predetermined work environment is known. As a related technique, JP 2022-080801 A discloses a cooperation management server that outputs advertisement information prompting transfer or lending of one or more materials used in agricultural works in response to accepting a know-how search request related to agricultural works.

### SUMMARY

For example, in response to distributing an advertisement to a worker in a distribution warehouse, an advertisement distribution system needs to select an advertisement that the worker is interested in and distribute the advertisement at a timing that does not hinder the work.

In view of the above-described problems, an object of the present disclosure is to provide a distribution control system, a distribution control method, and a program capable of appropriately distributing an advertisement to a worker.

A distribution control system according to one aspect of the present disclosure includes:

a worker attribute acquisition unit for acquiring a worker attribute indicating a worker attribute;

a work situation acquisition unit for acquiring a work situation of the worker;

an advertisement determination unit for determining an advertisement to be distributed to the worker based on the worker attribute and the work situation; and

a distribution control unit for controlling distribution of the advertisement.

A distribution control method according to one aspect of the present disclosure includes:

a worker attribute acquisition step of acquiring a worker attribute indicating a worker attribute;

a work situation acquisition step of acquiring a work situation of the worker;

an advertisement determination step of determining an advertisement to be distributed to the worker based on the worker attribute and the work situation; and

a distribution control step of controlling distribution of the advertisement.

A program according to one aspect of the present disclosure causes a computer to execute:

a worker attribute acquisition step of acquiring a worker attribute indicating a worker attribute;

a work situation acquisition step of acquiring a work situation of the worker;

an advertisement determination step of determining an advertisement to be distributed to the worker based on the worker attribute and the work situation; and

a distribution control step of controlling distribution of the advertisement.

An example of an effect of the distribution control system, the distribution control method, and the program according to the present disclosure is that an advertisement can be appropriately distributed to a worker.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a distribution control system according to the present disclosure;

FIG. 2 is a flowchart illustrating a flow of processing performed by the distribution control system according to the present disclosure;

FIG. 3 is a block diagram illustrating a configuration of the advertisement distribution system according to the present disclosure;

FIG. 4 is a diagram illustrating an example of a worker attribute DB according to the present disclosure;

FIG. 5 is a diagram illustrating an example of a schedule DB according to the present disclosure;

FIG. 6 is a diagram illustrating an example of a progress status DB according to the present disclosure;

FIG. 7 is a flowchart illustrating a flow of processing performed by a distribution control device according to the present disclosure; and

FIG. 8 is a block diagram illustrating a hardware configuration of a computer that implements the distribution control system and the like according to the present disclosure.

### EXAMPLE EMBODIMENT

Hereinafter, example embodiments of the present disclosure will be described in detail with reference to the drawings. In the drawings, the same or related elements are denoted by the same reference signs. For clarity of description, redundant description will be omitted as necessary.

### First Example Embodiment

### Distribution Control System 100

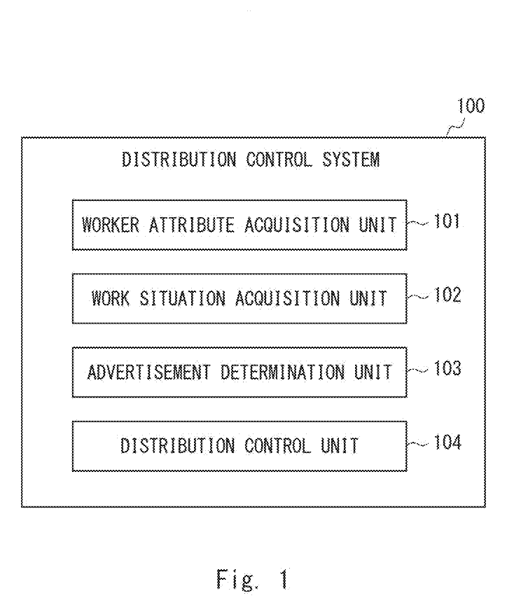

FIG. 1 is a block diagram illustrating a configuration of a distribution control system 100 according to the present disclosure. The distribution control system 100 includes a worker attribute acquisition unit 101, a work situation acquisition unit 102, an advertisement determination unit 103, and a distribution control unit 104. The worker attribute acquisition unit 101 acquires a worker attribute indicating a worker attribute. The work situation acquisition unit 102 acquires the work situation of the worker. The advertisement determination unit 103 determines an advertisement to be distributed to the worker based on the worker attribute and the work situation. The distribution control unit 104 controls the distribution of the advertisement.

The distribution control system 100 includes a processor, a memory, and a storage device as components (not illustrated). The storage device stores a computer program in which the processing according to the present disclosure is implemented. The processor may cause the computer program to be read from the storage device into the memory, and may execute the computer program. As a result, the processor implements the functions of the worker attribute acquisition unit 101, the work situation acquisition unit 102, the advertisement determination unit 103, and the distribution control unit 104.

Alternatively, each of the worker attribute acquisition unit 101, the work situation acquisition unit 102, the advertisement determination unit 103, and the distribution control unit 104 may be implemented by dedicated hardware. Some or all of the constituent components may be implemented by general-purpose or dedicated circuitry, a processor, or the like, or a combination thereof. These may be configured by a single chip, or may be configured by a plurality of chips connected via a bus. Some or all of the components may be achieved by a combination of the aforementioned circuitries or the like and the program.

### Processing of Distribution Control System 100

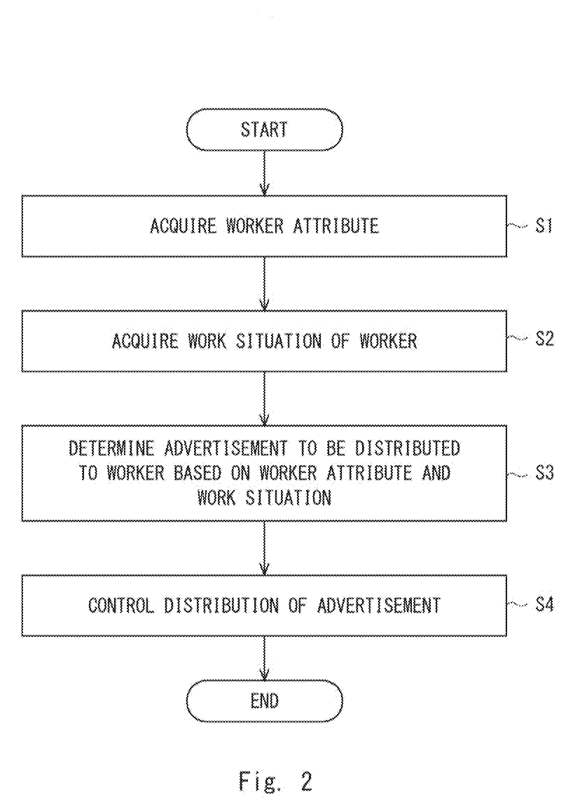

FIG. 2 is a flowchart illustrating a flow of processing performed by the distribution control system 100. First, the worker attribute acquisition unit 101 acquires a worker attribute (S1). Next, the work situation acquisition unit 102 acquires the work situation of the worker (S2). Subsequently, the advertisement determination unit 103 determines an advertisement to be distributed to the worker based on the worker attribute and the work situation (S3). Then, the distribution control unit 104 controls the distribution of the advertisement (S4).

As described above, according to the distribution control system 100 of the present disclosure, the advertisement to be distributed to the worker is determined based on the worker attribute and the work situation, and the distribution of the advertisement is controlled, so that the advertisement can be appropriately distributed to the worker.

### Second Example Embodiment

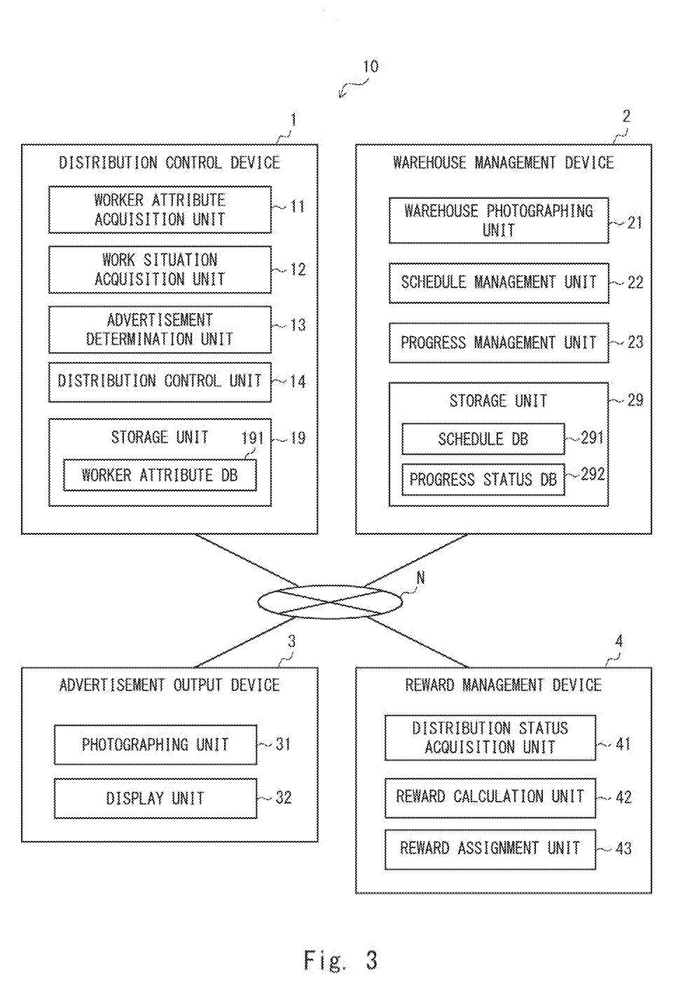

Subsequently, a second example embodiment will be described. A second example embodiment is a specific example of the first example embodiment described above. FIG. 3 is a block diagram illustrating a configuration of the advertisement distribution system 10 according to the present disclosure.

### Advertisement Distribution System 10

The advertisement distribution system 10 includes a distribution control device 1, a warehouse management device 2, an advertisement output device 3, and a reward management device 4. The distribution control device 1, the warehouse management device 2, the advertisement output device 3, and the reward management device 4 communicate with each other via the network N. The network N includes, for example, an Internet line, a wireless communication network, or the like, but the type of communication is not limited thereto.

The advertisement distribution system 10 is a system that distributes an advertisement to a worker who works in a predetermined work environment. The work environment is a space for a worker to perform a predetermined work. The work environment is, for example, a warehouse, a factory, a distribution center, an office, or the like, but is not limited thereto. Any work place may be used as the work environment. The work environment may be indoor or outdoor. Hereinafter, an example in which the work environment is a distribution warehouse (hereinafter, simply referred to as a “warehouse”) will be described. In addition, it is assumed that there are a plurality of workers who perform warehouse work in the warehouse.

In the advertisement distribution system 10, the distribution control device 1 acquires data from the warehouse management device 2 and the advertisement output device 3, performs predetermined processing using the acquired data, and distributes the advertisement to the advertisement output device 3. The warehouse management device 2 is an information processing device that manages a schedule of a worker and progress of work. The advertisement output device 3 is a terminal device used by a worker who views the advertisement. The advertisement output device 3 outputs the distributed advertisement by, for example, display. The distribution control device 1 distributes an advertisement to the advertisement output device 3 at a predetermined timing. The worker views the advertisement output from the advertisement output device 3.

Hereinafter, an example in which a glasses-type device is used as the advertisement output device 3 will be described. The glasses-type device is, for example, smart glasses or augmented reality (AR) glasses. For example, the advertisement output device 3 is configured to display a support image for supporting work. For example, the advertisement output device 3 is connected to a support image management device (not illustrated) via a network N. The advertisement output device 3 receives the support image transmitted from the support image management device, and displays the received support image on the display unit 32.

For example, it is assumed that the worker is in charge of picking work in a warehouse. The worker advances the work while wearing the advertisement output device 3. In a case where the advertisement output device 3 is AR glasses, the advertisement output device 3 displays the shelf number of the picking target product and the correct arrangement place in an overlapping manner in the field of view of the worker. As a result, even an inexperienced worker can intuitively find a product and accurately take out the product from the shelf. The support image may be a still image or a moving image.

In this manner, the worker can perform the work while wearing the advertisement output device 3, and can perform the work while viewing the support image displayed on the advertisement output device 3 as necessary. In addition, the worker can view the advertisement distributed to the advertisement output device 3 between works or in a break time zone without using another device. Each configuration of the advertisement distribution system 10 will be described below.

### Distribution Control Device 1

The distribution control device 1 is an example of the distribution control system 100 described above. The distribution control device 1 is a control device that controls distribution of an advertisement in the advertisement distribution system 10. For example, the distribution control device 1 may be implemented by a server device or a cloud system that provides advertisement distribution services. The distribution control device 1 includes a worker attribute acquisition unit 11, a work situation acquisition unit 12, an advertisement determination unit 13, a distribution control unit 14, and a storage unit 19.

The worker attribute acquisition unit 11 is an example of the worker attribute acquisition unit 101 described above. The worker attribute acquisition unit 11 acquires a worker attribute. The worker attribute is, for example, the age, sex, or family structure of the worker. The worker attribute is not limited thereto, and may include any matter related to the worker. For example, the worker attribute may include information of a work area which the worker is in charge of.

The worker attribute acquisition unit 11 refers to, for example, a worker attribute database (DB) 191 of the storage unit 19 to acquire the worker attribute. The worker attribute DB 191 stores in advance worker attributes acquired via a worker terminal (not illustrated) used by a worker. The worker terminal may be, for example, a device such as a personal computer (PC) or a smartphone.

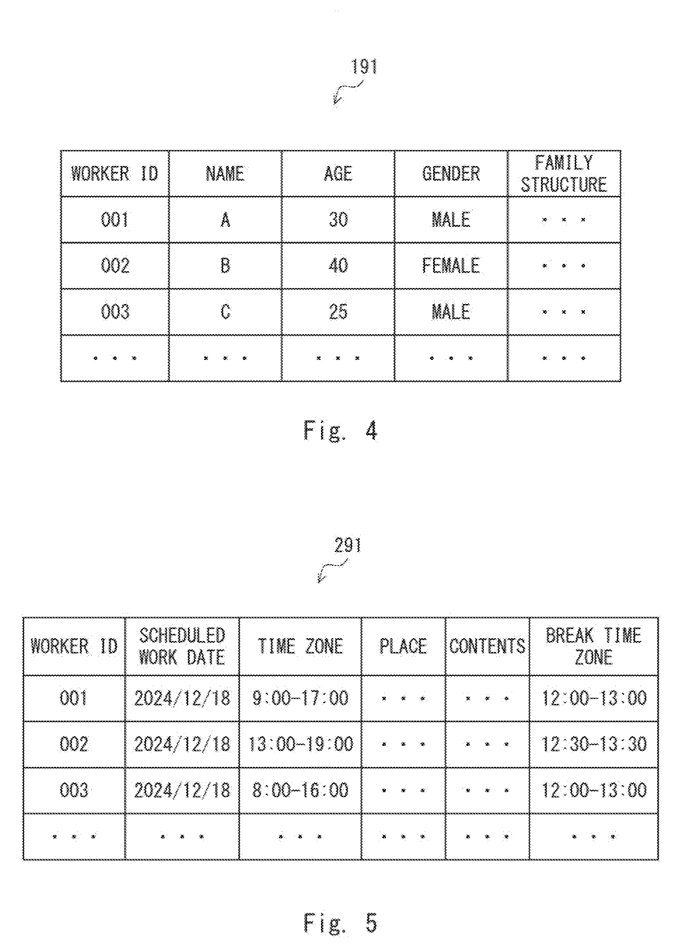

FIG. 4 is a diagram illustrating an example of the worker attribute DB 191. In this example, the worker attribute DB 191 includes information of a worker ID, a name, an age, a gender, and a family structure. The worker ID is information for identifying a worker. The name is information indicating the name of the worker. The age is information indicating the age based on the date of birth of the worker. The gender is information indicating the gender of the worker. The family structure is information indicating presence or absence of a family of the worker, the number of family members, and the like. Since these are examples, the contents of the worker attribute DB 191 may be changed as appropriate. For example, a genre or the like in which the worker is interested may be included as the worker attribute.

The worker attribute acquisition unit 11 first identifies a worker ID corresponding to a worker wearing the advertisement output device 3. For example, the worker attribute acquisition unit 11 can acquire the worker ID identified according to the success of the biometric authentication of the worker from the advertisement output device 3.

For example, the advertisement output device 3 authenticates the worker using the iris authentication function. Specifically, the advertisement output device 3 identifies the worker ID by photographing the iris of the worker using a photographing unit 31 and performing authentication processing. For example, the advertisement output device 3 performs iris authentication by transmitting the iris image and the biometric authentication request to an authentication device (not illustrated) connected to the network N. In a case where the iris authentication succeeds, the advertisement output device 3 acquires the identified worker ID from the authentication device. The advertisement output device 3 transmits the acquired worker ID to the distribution control device 1. As a result, the worker attribute acquisition unit 11 acquires the worker ID of the worker wearing the advertisement output device 3.

The worker attribute acquisition unit 11 refers to the worker attribute DB 191 and acquires the worker attribute associated with the acquired worker ID. The worker attribute acquisition unit 11 outputs the acquired worker attribute to the work situation acquisition unit 12. As a result, the work situation acquisition unit 12 can determine an advertisement suitable for the worker. Although the iris authentication is used here, the biometric authentication method is not limited thereto. For example, a biometric authentication method such as face authentication may be used.

The description will refer back to FIG. 3. The work situation acquisition unit 12 is an example of the work situation acquisition unit 102 described above. The work situation acquisition unit 12 acquires the work situation of the worker. For example, the work situation acquisition unit 12 first acquires photographed images from a warehouse photographing unit 21 of the warehouse management device 2 or the photographing unit 31 of the advertisement output device 3. The work situation acquisition unit 12 analyzes the photographed images using any image analysis technology. The work situation acquisition unit 12 acquires the work situation based on the analysis result. The work situation is information indicating a work situation of the worker. For example, the work situation may include information such as “the worker is working”, “the worker is not working”, and “the worker is taking a break”.

The advertisement determination unit 13 is an example of the advertisement determination unit 103 described above. The advertisement determination unit 13 determines an advertisement to be distributed to the worker based on the worker attribute and the work situation. For example, the advertisement determination unit 13 determines an advertisement attribute indicating an attribute of the advertisement, and determines an advertisement to be distributed to the worker based on the determined advertisement attribute. The advertisement attribute is, for example, the type, content, or playing time of the advertisement.

The type of advertisement is, for example, a moving image advertisement, a still image advertisement, a voice advertisement, or the like. The advertisement determination unit 13 may select any type based on the worker attribute. The content of the advertisement is, for example, product introduction, service guidance, entertainment content, or the like. The advertisement determination unit 13 customizes the content of products or services to be included in the advertisement according to the age and gender of the worker, and selects an advertisement that is assumed to attract the interest of the worker. Accordingly, the advertisement determination unit 13 can select an advertisement suitable for the worker.

The playing time of the advertisement is a length of the advertisement to be distributed. The advertisement determination unit 13 determines a playing time that is assumed not to be a burden of work based on the work situation of the worker. The advertisement determination unit 13 may select an advertisement according to the determined playing time, or may determine to shorten a long advertisement or to play an advertisement at a double speed.

The distribution control unit 14 is an example of the distribution control unit 104 described above. The distribution control unit 14 controls distribution of an advertisement to the advertisement output device 3. For example, in a case where the advertisement output device 3 is a glasses-type device such as AR glasses, the distribution control unit 14 controls the distribution in such a way that the advertisement is displayed on the advertisement output device 3 regardless of the operation of the worker. As a result, the worker can easily view the advertisement without performing an operation for displaying the advertisement.

In a case where the advertisement output device 3 is a smartphone, a tablet terminal, or the like, the distribution control unit 14 may distribute an advertisement in response to a request of a worker. For example, the distribution control unit 14 may distribute the advertisement in a case where the worker operates the smartphone during the break time and requests or allows the distribution of the advertisement.

The distribution control unit 14 controls distribution and distribution stop of the advertisement. The distribution control unit 14 determines a distribution timing including at least one of a distribution start timing and a distribution end timing of the advertisement based on the work situation, and distributes the advertisement based on the determined distribution timing.

For example, the distribution control unit 14 may specify a viewable time zone indicating a time zone in which the worker can view the advertisement, and determine the distribution timing based on the specified viewable time zone. Specifically, the distribution control unit 14 acquires the schedule of the worker from a schedule DB 291 stored in the storage unit 29 of the warehouse management device 2. The distribution control unit 14 specifies the viewable time zone of the worker based on the acquired schedule.

FIG. 5 is a diagram illustrating an example of the schedule DB 291. The schedule DB 291 includes a worker ID, a scheduled work date, a time zone, a place, a content, and a break time zone. The worker ID corresponds to the worker ID of FIG. 4. The scheduled work date is a date on which work is scheduled. The time zone, place, content, and break time zone are the time zone, place, content, and break time zone of the work scheduled on the scheduled work date.

The viewable time zone is, for example, a break time zone, a time zone before starting work, a time zone after finishing work, a waiting time between work, or the like. The distribution control unit 14 determines the distribution timing such that the advertisement is distributed between the start and the end of the viewable time zone. For example, the distribution control unit 14 may specify the break time zone of the worker as the viewable time zone, determine the start time of the break time zone as the distribution start timing, and determine the end time of the break time zone as the distribution end timing.

For example, in the example of FIG. 5, the worker with the worker ID “001” has a break time zone from 12:00 to 13:00. In this case, the distribution control unit 14 determines 12:00 as the distribution start timing and 13:00 as the distribution end timing. In this way, the distribution control unit 14 can determine the distribution timing of the advertisement in conjunction with the schedule of the worker registered in advance. As a result, the distribution control unit 14 can determine the distribution timing in such a way that the advertisement is distributed during free time of work, for example. The distribution control unit 14 may collectively specify the viewable time zone for a plurality of workers. For example, the distribution control unit 14 may specify a basic break time (for example, 12:00 to 13:00) applied to all workers in the warehouse as the viewable time zone.

In addition, the distribution control unit 14 may monitor whether the worker is in a safe situation based on at least one of the worker's safety situation and the work situation, and determine the distribution timing based on the monitoring result. In a case where the worker is not in a safe situation, the distribution control unit 14 determines the distribution timing in such a way as to prevent the distribution of the advertisement. For example, the distribution control unit 14 may determine not to distribute the advertisement in a case where the worker is not in a safe situation. Furthermore, the distribution control unit 14 may reduce the number of times and period of time of distributing the advertisement as compared with a case where the worker is in a safe situation.

The safety situation indicates a situation of the worker or around the worker. The safety situation may include information regarding safety of the worker or around the worker. The safety situation includes information on whether the work that the worker is doing or the work environment of the worker includes danger.

Examples of the work performed by the worker including danger include working at a high place, carrying heavy goods, operating a machine, handling dangerous goods, and the like. Examples of the work environment of the worker including danger include a sharp tool around the worker, chemicals placed around the worker, a shelf that easily falls, a heavy machine, and the like.

For example, the distribution control unit 14 acquires photographed images of the warehouse photographing unit 21 of the warehouse management device 2 and the photographing unit 31 of the advertisement output device 3, and specifies the safety situation of the worker based on the acquired photographed images. The distribution control unit 14 analyzes the photographed images using any image analysis technology and specifies the safety situation of the worker.

The present invention is not limited thereto, and the distribution control unit 14 may specify the safety situation based on information acquired from sensors included in the advertisement output device 3. For example, it is assumed that the advertisement output device 3 includes an acceleration sensor and a gyro sensor. The distribution control unit 14 specifies the motion state of the worker based on the information acquired from these sensors. For example, the acceleration sensor detects the moving speed of the worker and the presence or absence of sudden movement. In addition, the gyro sensor detects a change in inclination and a change in posture of the worker.

The distribution control unit 14 acquires detection results from the acceleration sensor and the gyro sensor, and specifies the safety situation based on the acquired detection results. In addition to the detection results of these sensors, the distribution control unit 14 may specify the safety situation based on the photographed images of the warehouse photographing unit 21 and the photographing unit 31. For example, the distribution control unit 14 can accurately specify the safety situation by combining the detection results of the acceleration sensor and the gyro sensor of the advertisement output device 3 and the photographed images of the warehouse photographing unit 21.

The distribution control unit 14 determines whether the worker is in a safe situation based on at least one of the worker's safety situation and the work situation. For example, the distribution control unit 14 determines whether the worker is “in a safe situation” or “not in a safe situation” based on the safety situation of the worker described above. For example, the distribution control unit 14 determines that the worker is not in a safe situation in a case where the work that the worker is doing or the work environment of the worker includes danger. The distribution control unit 14 may indicate whether it is in a safe situation by a numerical value or a level.

Furthermore, the distribution control unit 14 may make the determination based on the work situation of the worker. For example, in a case where the worker is performing some work, the distribution control unit 14 may determine that the worker is not in a safe situation.

In a case where the worker is not in a safe situation, the distribution control unit 14 may determine the distribution timing in such a way as not to distribute the advertisement until the worker is in a safe situation. For example, the distribution control unit 14 can adjust the distribution timing of the advertisement, such as distributing the advertisement after the work of the worker is finished or distributing the advertisement after there is no sharp tool around. As a result, the distribution control unit 14 can distribute the advertisement at the distribution timing in consideration of the safety of the worker. The distribution control unit 14 may stop the advertisement being distributed in a case where the worker in the safe situation is no longer in the safe situation.

Furthermore, the distribution control unit 14 may control the distribution of the advertisement based on the progress status of the work in the worker or the work group. For example, the distribution control unit 14 acquires the progress status from a progress status DB 292 stored in the storage unit 29 of the warehouse management device 2. The progress status may be a progress status of a specific worker or a progress status of a work group including a plurality of workers. The distribution control unit 14 may determine the distribution timing based on the progress rate indicating the degree of progress.

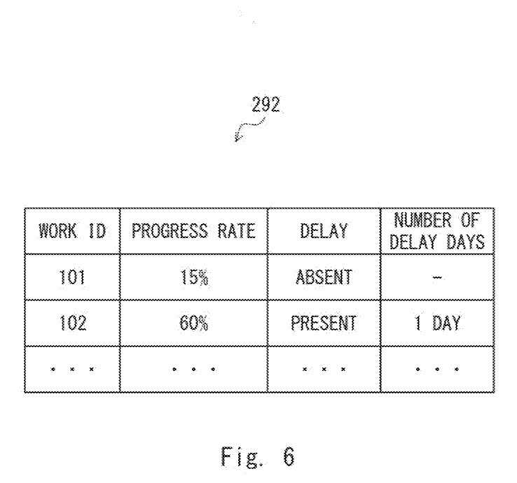

FIG. 6 is a diagram illustrating an example of the progress status DB 292. The progress status DB 292 includes a work ID, a progress rate, a delay, and the number of delay days. The work ID is information for identifying the work. The progress rate is information indicating the progress status of the work, and represents the completion rate of the work with respect to the overall plan as a percentage. The delay is information indicating whether the work is behind schedule. The number of delay days is information indicating how much the work is delayed from the schedule by the number of days.

The distribution control unit 14 may determine at least one of the advertisement attribute and the distribution timing of the advertisement to be distributed based on the progress rate. For example, in a case where the progress rate is less than a threshold value, the distribution control unit 14 determines the content and the distribution timing in such a way that the distribution time of the advertisement is shorter than that in a case where the progress rate is equal to or greater than the threshold value.

Furthermore, the distribution control unit 14 may make at least one of the distribution timing and the advertisement attribute different between the case where a delay has occurred in the progress status and the case where no delay has occurred. Here, “differing the distribution timing” includes differing the presence or absence of delivery between a case where a delay has occurred in the progress status and the case where no delay has occurred. For example, the distribution control unit 14 may control the distribution of the advertisement in such a way that the advertisement is not distributed in a case where a delay has occurred, and the advertisement is distributed in a case where no delay has occurred.

Furthermore, for example, the distribution control unit 14 may select product introduction in a case where a delay has occurred, and entertainment content in a case where no delay has occurred, as the type of advertisement. In addition, the distribution control unit 14 may select an advertisement having a relatively short playing time in a case where a delay has occurred, and may select an advertisement having a relatively long playing time in a case where no delay has occurred. The present invention is not limited thereto, and the distribution control unit 14 may appropriately select the advertisement attribute in order to prevent occurrence and increase of delay.

The storage unit 19 stores various data and programs. At least a part of the storage unit 19 is configured by a non-volatile memory in such a way that the data is retained even if the power supply of the distribution control device 1 is turned off. The storage unit 19 stores the worker attribute DB 191 described above.

### Warehouse Management Device 2

The warehouse management device 2 is a system for managing work in a warehouse. The warehouse management device 2 includes a warehouse photographing unit 21, a schedule management unit 22, a progress management unit 23, and a storage unit 29.

The warehouse photographing unit 21 is a photographing device for photographing the inside of the warehouse. The warehouse photographing unit 21 is, for example, a camera. The warehouse photographing unit 21 may be a fixed camera, or may be a full dome camera capable of photographing the surroundings at a view angle of 360 degrees. The warehouse management device 2 may include a plurality of warehouse photographing units 21. The plurality of warehouse photographing units 21 is provided on, for example, a ceiling or a wall surface of the warehouse, and performs photographing in a predetermined direction. For example, the warehouse photographing unit 21 is provided in a work area, a rest area, a storage area, a receiving area, a shipping area, an article shelf, a passage, an inspection area, or the like. The warehouse photographing unit 21 photographs workers, baggage, products, or the like in each area.

The warehouse photographing unit 21 transmits the photographed images obtained by photographing to the distribution control device 1. The warehouse photographing unit 21 may transmit the photographed images in real time or at predetermined time intervals. The photographed image may be a still image or a moving image.

The schedule management unit 22 manages the schedule of the worker. The schedule management unit 22 manages, for example, an attendance schedule, a work schedule, a break schedule, or the like of the worker. For example, the schedule management unit 22 receives registration of a schedule from the worker via the worker terminal. The worker registers his/her schedule in the schedule management unit 22 via a predetermined application, for example.

Not limited to this, a manager who manages the worker's schedule may register the schedule. The manager registers the schedule of the worker in the schedule management unit 22 via a manager terminal (not illustrated). For example, the schedule management unit 22 may collectively register breaks (for example, a lunch break) taken by all workers at the same time. The schedule management unit 22 stores the schedule of the worker in the schedule DB 291 of the storage unit 29. Since the schedule DB 291 is as described with reference to FIG. 5, a detailed description thereof will be omitted.

The progress management unit 23 manages the progress status of work by the worker or the work group. For example, it is assumed that the progress management unit 23 manages the progress status of the picking work. The progress management unit 23 acquires a result of reading a tag of a product on a shelf by a barcode reader or a radio frequency identification (RFID) reader via the network N connected to these readers.

The progress management unit 23 manages the progress status of the work based on the acquired reading result. Every time the worker reads the tag of the product, the progress management unit 23 records completion of the corresponding work item in the progress status DB 292 and updates the progress rate of the work. As a result, the progress management unit 23 can manage the progress status of the work in real time. Since the progress status DB 292 is as described with reference to FIG. 6, a detailed description thereof will be omitted.

The method of managing the progress status is not limited thereto. The progress management unit 23 may manage the progress status by analyzing the photographed images of the warehouse photographing unit 21. The progress management unit 23 may update the progress status DB 292 by receiving completion of the work from the worker via the worker terminal or the like.

The storage unit 29 stores various data and programs. At least a part of the storage unit 29 is configured by a non-volatile memory in such a way that the data is retained even if the power supply of the warehouse management device 2 is turned off. In addition, the storage unit 29 stores the schedule DB 291 and the progress status DB 292 described above.

### Advertisement Output Device 3

The advertisement output device 3 is a device that outputs an advertisement. The advertisement output device 3 includes a photographing unit 31 and a display unit 32. The advertisement output device 3 is, for example, a glasses-type device capable of displaying a support image for supporting the work of the worker. The worker performs work by wearing the advertisement output device 3 that is a glasses-type device. Not limited thereto, the advertisement output device 3 may be a smartphone, a tablet terminal, or the like. The advertisement output device 3 only needs to be able to output the advertisement distributed by the distribution control device 1.

The photographing unit 31 is a photographing device for photographing the surroundings of the advertisement output device 3. The photographing unit 31 is incorporated in a frame or a bridge portion of the advertisement output device 3 that is, for example, a glasses-type device. Therefore, the photographing unit 31 photographs a predetermined direction from the vicinity of the worker's eyes. The photographing unit 31 is, for example, a high-resolution camera.

The photographing unit 31 can photograph a range within the field of view of the worker while the worker is moving or working. The photographing unit 31 may be configured to be capable of photographing the line-of-sight direction of the worker. The photographing unit 31 photographs, for example, a work area, a rest area, a storage area, a receiving area, a shipping area, an article shelf, a passage, or an inspection area. For example, in a case where the worker is performing work at hand, the photographing unit 31 photographs the vicinity of the hand of the worker.

The photographing unit 31 transmits the photographed images obtained by photographing to the distribution control device 1 via a communication unit (not illustrated). The photographing unit 31 may transmit the image data in real time or at predetermined time intervals. The photographed image may be a still image or a moving image. In addition, the photographing unit 31 photographs a region including the worker's eyes and acquires an iris image used for iris authentication of the worker.

The display unit 32 is a display device that displays an advertisement. The display unit 32 is, for example, a display. The display unit 32 may be, for example, an organic light emitting diode (OLED) display or the like. The display unit 32 is configured to display advertisements and various types of information in the field of view of the worker. The display unit 32 may be a display different from the glasses-type device. For example, the display unit 32 may be a display unit of a terminal device such as a smartphone used by the worker.

The advertisement output device 3 may have a voice output function. For example, the advertisement output device 3 may include a bone conduction speaker or a small speaker, and may output a voice included in the advertisement from the speaker.

### Reward Management Device 4

The reward management device 4 is an information processing device that sets a reward to the worker according to the distribution status of the advertisement. The reward to the worker is a financial reward or an incentive given to the worker according to the distribution status of the advertisement. The reward may be set with points or the like that can be used in a predetermined point system. The reward management device 4 includes a distribution status acquisition unit 41, a reward calculation unit 42, and a reward assignment unit 43.

The distribution status acquisition unit 41 acquires the distribution status of the advertisement. For example, the distribution status acquisition unit 41 acquires the distribution status of the advertisement for each worker from the distribution control device 1. The distribution status may include, for example, the number of distributed advertisements, the total distribution time, the number of advertisements whose viewing has been completed, or the like. The distribution status is used to calculate a reward to the worker.

The reward calculation unit 42 calculates a reward to the worker based on the distribution status. For example, the reward calculation unit 42 calculates the reward by multiplying the unit price of the distributed advertisement by the total distribution time. The reward calculation unit 42 may adjust the reward according to an advertisement attribute (for example, the type, content, or playing time of the advertisement) or a worker attribute (for example, age, gender, or family structure). The reward calculation unit 42 may be configured to return the presence or absence of interest in the distributed advertisement by, for example, the number of stars. In a case where the presence or absence of interest in the advertisement is returned, the reward calculation unit 42 may adjust the reward in such a way that an additional reward is given to the worker. In addition, the reward calculation unit 42 may reflect the presence or absence of interest in the advertisement in the worker attribute DB 191. As a result, the distribution control device 1 can distribute an advertisement in which personal preference is more reflected.

The reward assignment unit 43 assigns the reward calculated by the reward calculation unit 42 to the worker. For example, the reward assignment unit 43 reflects the reward in the worker's salary system. The reward assignment unit 43 may assign a point to the worker via a point system (not illustrated).

Here, an example in which the reward management device 4 manages the reward has been described, but the present invention is not limited thereto. The distribution control device 1 may have a function of the reward management device 4 to manage the reward. In that case, for example, the distribution control device 1 further includes a reward management unit having the function of the reward management device 4. The reward management unit has the functions of the distribution status acquisition unit 41, the reward calculation unit 42, and the reward assignment unit 43.

The configuration of advertisement distribution system 10 has been described above. The configuration of the above-described advertisement distribution system 10 is merely an example, and can be appropriately changed. For example, if some or all of the components of the distribution control device 1, the warehouse management device 2, the advertisement output device 3, and the reward management device 4 are implemented by a plurality of information processing devices, circuits, and the like, the plurality of information processing devices, circuits, and the like may be disposed in a centralized manner or in a distributed manner. For example, each of the information processing devices, circuitry, and the like may be implemented in the form of a client server system, a cloud computing system, or the like in which they are connected to each other through a communication network. The functions of the distribution control device 1, the warehouse management device 2, and the reward management device 4 may be provided in a software as a service (SaaS) format.

For example, although the storage unit 19 is illustrated inside the distribution control device 1 in FIG. 2, the storage unit 19 may be provided in a device other than the distribution control device 1. In FIG. 2, the warehouse photographing unit 21 is illustrated inside the warehouse management device 2, but the warehouse photographing unit 21 may be provided in another photographing system or the like.

### Processing of Distribution Control Device 1

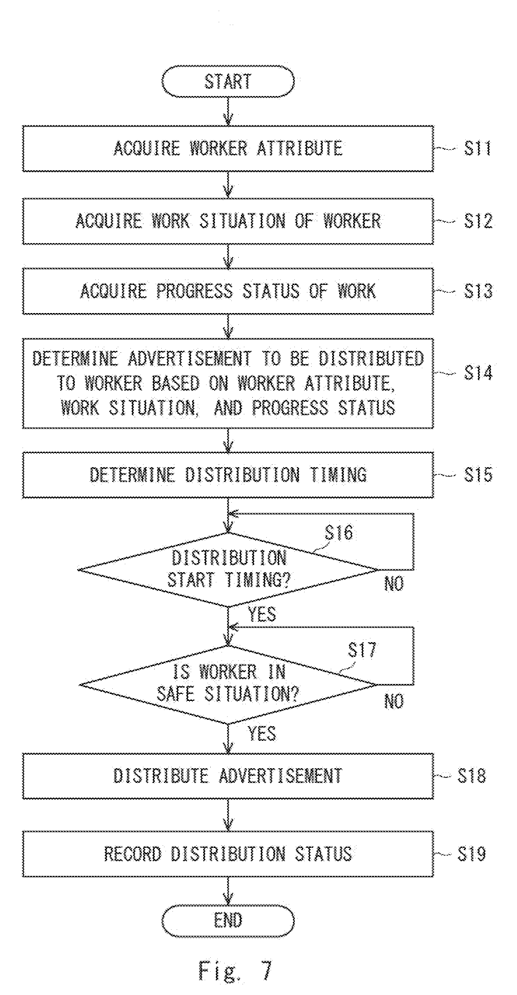

Next, processing performed by the distribution control device 1 will be described with reference to FIG. 7. FIG. 7 is a flowchart illustrating a flow of processing performed by the distribution control device 1.

First, the worker attribute acquisition unit 11 acquires the worker attribute from the worker attribute DB 191 (S11). Next, the work situation acquisition unit 12 acquires the current work situation of the worker (S12). For example, the work situation acquisition unit 12 acquires photographed images from a warehouse photographing unit 21 of the warehouse management device 2 or the photographing unit 31 of the advertisement output device 3, and analyzes the photographed images. The work situation acquisition unit 12 acquires the work situation based on the analysis result. For example, the work situation acquisition unit 12 acquires a work situation such as “the worker is working”, “the worker is not working”, or “the worker is taking a break”.

Next, the distribution control unit 14 acquires the work progress status (S13). For example, the distribution control unit 14 acquires the progress status from a progress status DB 292 stored in the storage unit 29 of the warehouse management device 2. The progress status may be a progress status of a specific worker or a progress status of a work group. The distribution control unit 14 acquires information on the progress rate and the presence or absence of delay.

Subsequently, the advertisement determination unit 13 determines an advertisement to be distributed to the worker based on the acquired worker attribute, work situation, and progress status (S14). For example, the advertisement determination unit 13 determines the advertisement attribute based on the worker attribute and the work situation, and determines the advertisement based on the determined advertisement attribute. Furthermore, for example, in a case where a delay has occurred in the progress status, the advertisement determination unit 13 may select an advertisement whose playing time is shorter than that in a case where no delay has occurred. In addition, the advertisement determination unit 13 may determine not to distribute the advertisement in a case where a delay equal to or more than a predetermined delay has occurred. For example, the advertisement determination unit 13 may determine whether the progress rate is less than a predetermined threshold value, and make the determination based on the determination result.

Subsequently, the distribution control unit 14 determines a distribution timing (S15). For example, in a case where the worker is not working or is on a break, the distribution control unit 14 may determine the distribution start timing in such a way as to start distribution promptly. Furthermore, in a case where the worker is working, the distribution control unit 14 may acquire the schedule of the worker, specify the viewable time zone, and determine the distribution timing based on the specified viewable time zone. The distribution control unit 14 can acquire the schedule of the worker from a schedule DB 291 stored in the storage unit 29 of the warehouse management device 2.

Subsequently, the distribution control unit 14 determines whether the current time reaches the distribution start timing (S16). In a case where it is determined that it is not the distribution start timing (NO in S16), the process of step S16 is repeated. In a case where it is determined that it is the distribution start timing (YES in S16), the distribution control unit 14 determines whether the worker is in a safe situation (S17).

In a case where it is determined that the worker is not in the safe situation (NO in S17), the processing in step S17 is repeated until it is determined that the worker is in the safe situation. As a result, the distribution control unit 14 can prevent distribution of the advertisement in a case where the worker is not in a safe situation.

In a case where it is determined that the worker is in a safe situation (YES in S17), the distribution control unit 14 distributes an advertisement (S18). The distribution control unit 14 continues distribution of the advertisement until the determined distribution termination timing. The distribution control unit 14 may constantly monitor whether the worker is in a safe situation, and may stop the distribution in a case where it is determined that the worker is not in the safe situation.

Subsequently, the distribution control unit 14 records the distribution status of the advertisement (S19). For example, the distribution control unit 14 transmits the distribution status to the reward management device 4. The distribution status may include the worker ID, the content of the distributed advertisement, the distribution time, or the like. The distribution control unit 14 may temporarily store the distribution status in the storage unit 19, and may collectively transmit the plurality of distribution statuses to the reward management device 4 after a predetermined time elapses.

Although not illustrated, the reward management device 4 sets a reward to the worker according to the distribution status of the advertisement and gives the reward. Specifically, the distribution status acquisition unit 41 acquires the distribution status from the distribution control device 1. The reward calculation unit 42 calculates a reward to the worker based on the distribution status. The reward assignment unit 43 gives a reward to the worker.

As described above, in the advertisement distribution system 10 according to the present disclosure, the distribution control device 1 determines an advertisement to be distributed to the worker based on the worker attribute and the work situation. Since the distribution control device 1 can determine the distribution timing based on the work situation, it is possible to appropriately distribute the advertisement to the worker.

In addition, since the distribution control device 1 can acquire the schedule of the worker and determine the distribution timing based on the acquired schedule, it is possible to distribute the advertisement in a viewable time zone such as a break time.

Furthermore, since the distribution control device 1 can monitor whether the worker is in a safe situation and determine the distribution timing in such a way as not to distribute the advertisement in a case where the worker is not in the safe situation, it is possible to distribute the advertisement while securing the safety of the worker and the surroundings.

Then, since the distribution control device 1 can control the distribution of the advertisement based on the progress of the work, for example, in a case where a delay has occurred in the progress status, the distribution control device 1 can determine a distribution timing and an advertisement attribute different from those in a case where no delay has occurred.

With such a configuration, the advertisement distribution system 10 can achieve both improvement in productivity and securing of safety while providing the worker with the enjoyment of advertisement viewing. As a result, the advertisement distribution system 10 can contribute to improvement of attraction of warehouse work.

Furthermore, in the advertisement distribution system 10, as the advertisement output device 3, AR glasses or the like used for instructing warehouse work is also used for advertisement distribution. As a result, the advertisement distribution system 10 can reduce the cost of advertisement distribution and implement seamless advertisement viewing in the warehouse work.

Moreover, in the advertisement distribution system 10, a reward can be assigned to the worker according to the distribution status of the advertisement. Therefore, there are advantages that the worker can relax between works and can acquire additional revenue. Further, the advertiser can distribute an advertisement to a target having an appropriate worker attribute, and does not need to create a leaflet or the like, so that there is an advantage that cost reduction for providing an advertisement can be achieved. For the warehouse business operator, there is an advantage that motivation of the worker can be increased by supplying an incentive to the worker.

### Configuration Example of Hardware

The functional configuration units of the distribution control system 100, the distribution control device 1, the warehouse management device 2, the advertisement output device 3, and the reward management device 4 (hereinafter, referred to as “distribution control system 100 and the like”) may be implemented by hardware (for example, a hard-wired electronic circuit or the like) that achieves each functional configuration unit, or may be achieved by a combination of hardware and software (for example, a combination of an electronic circuit and a program for controlling the electronic circuit or the like). Hereinafter, a case where each functional configuration unit of the distribution control system 100 and the like is achieved by a combination of hardware and software will be further described.

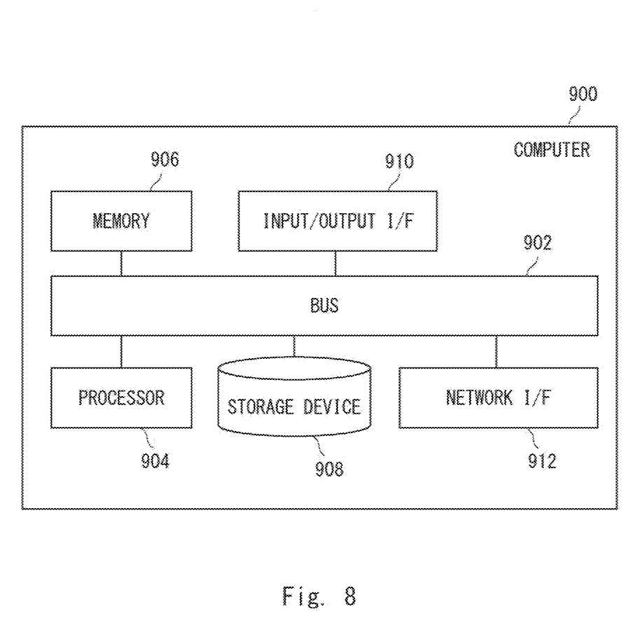

FIG. 8 is a block diagram illustrating a hardware configuration of a computer 900 that implements the distribution control system 100 and the like. A computer 900 may be a dedicated computer designed to achieve the distribution control system 100 and the like, or may be a general-purpose computer. The computer 900 may be a portable computer, such as a smartphone, a tablet terminal, or the like.

For example, by installing a predetermined application in the computer 900, each function of the distribution control system 100 and the like is achieved in the computer 900. The application is configured by a program for achieving a functional configuration unit of the distribution control system 100 and the like.

The computer 900 includes a bus 902, a processor 904, a memory 906, a storage device 908, an input/output interface 910, and a network interface 912. The bus 902 is a data transmission path through which the processor 904, the memory 906, the storage device 908, the input/output interface 910, and the network interface 912 mutually exchange data. However, a method for connecting the processor 904 and the like to each other is not limited to the bus connection.

The processor 904 is various processors such as a central processing unit (CPU), a graphics processing unit (GPU), a field-programmable gate array (FPGA), or a quantum processor (quantum computer control chip). The memory 906 is a main storage device implemented using a random access memory (RAM) or the like. The storage device 908 is an auxiliary storage device implemented using a hard disk, a solid state drive (SSD), a memory card, a read only memory (ROM), or the like.

The input/output interface 910 is an interface for connecting the computer 900 with an input/output device. For example, an input device such as a keyboard and an output device such as a display device are connected to the input/output interface 910.

The network interface 912 is an interface for connecting the computer 900 to a network. The network may be a local area network (LAN), or may be a wide area network (WAN).

The storage device 908 stores a program for achieving each functional configuration unit such as the distribution control system 100 (a program for achieving the above-described application). The processor 904 reads the program into the memory 906 and executes the program to implement each functional component of the distribution control system 100 and the like.

Each of the processors executes one or more programs including instructions for causing a computer to perform an algorithm. The program includes instructions (or software codes) for causing the computer to implement one or more functions described in the example embodiments in a case of being read by the computer. The program may be stored in various types of non-transitory computer-readable media or tangible storage media. By way of example, and not limitation, non-transitory computer-readable media or tangible storage media include RAM, ROM, flash memory, SSD or other memory technology, CD-ROM, digital versatile disc (DVD), Blu-ray® disk or other optical disk storage, magnetic cassettes, magnetic tape, magnetic disk storage, or other magnetic storage devices. The program may also be transmitted in the various types of transitory computer-readable media or a communication medium. As an example and not by way of limitation, the transitory computer-readable medium or the communication medium includes electric, optical, acoustic, or any other form of propagation signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each drawing is merely illustrative for describing one or more example embodiments. Each of the drawings is not associated with only one specific example embodiment, but may be associated with one or more other example embodiments. As those of ordinary skill in the art will appreciate, various features or steps described with reference to any one of the figures may be combined with features or steps shown in one or more other figures, for example, to create example embodiments that are not explicitly illustrated or described. All of the features or steps shown in any one of the figures for describing the exemplary example embodiments are not necessarily mandatory, and some features or steps may be omitted. The order of the steps described in any one of the drawings may be changed as appropriate.

Some or all of the above example embodiments may be described as the following Supplementary Notes, but are not limited to the following.

### Supplementary Note 1

A distribution control system including:

a worker attribute acquisition unit for acquiring a worker attribute indicating a worker attribute;

a work situation acquisition unit for acquiring a work situation of the worker;

an advertisement determination unit for determining an advertisement to be distributed to the worker based on the worker attribute and the work situation; and

a distribution control unit for controlling distribution of the advertisement.

### Supplementary Note 2

The distribution control system according to Supplementary Note 1, wherein

the distribution control unit determines a distribution timing including at least one of a distribution start timing and a distribution end timing of the advertisement based on the work situation, and distributes the advertisement based on the determined distribution timing.

### Supplementary Note 3

The distribution control system according to Supplementary Note 2, wherein

the distribution control unit acquires a schedule of the worker, specifies a viewable time zone indicating a time zone in which the worker can view the advertisement based on the acquired schedule, and determines the distribution timing based on the specified viewable time zone.

### Supplementary Note 4

The distribution control system according to Supplementary Note 3, wherein

the distribution control unit specifies a break time zone of the worker as the viewable time zone, determines a start time of the break time zone as the distribution start timing, and determines an end time of the break time zone as the distribution end timing.

### Supplementary Note 5

The distribution control system according to any one of Supplementary Notes 2 to 4, wherein

the distribution control unit monitors whether the worker is in a safe situation based on at least one of a safety situation of the worker and the work situation, and determines the distribution timing in such a way as to prevent distribution of the advertisement in a case where the worker is not in the safe situation.

### Supplementary Note 6

The distribution control system according to any one of Supplementary Notes 2 to 5, wherein

the distribution control unit controls distribution of the advertisement based on a progress status of work in the worker or a work group, and makes at least one of the distribution timing and an advertisement attribute indicating an attribute of the advertisement different between a case where a delay has occurred in the progress status and a case where no delay has occurred.

### Supplementary Note 7

The distribution control system according to any one of Supplementary Notes 1 to 6, further including:

a reward setting unit for setting a reward to the worker according to a distribution status of the advertisement.

### Supplementary Note 8

The distribution control system according to any one of Supplementary Notes 1 to 7, wherein

the worker performs the work by wearing a glasses-type device for displaying a support image for supporting the work, and

the distribution control unit distributes the advertisement to the glasses-type device.

### Supplementary Note 9

A distribution control method including:

a worker attribute acquisition step of acquiring a worker attribute indicating a worker attribute;

a work situation acquisition step of acquiring a work situation of the worker;

an advertisement determination step of determining an advertisement to be distributed to the worker based on the worker attribute and the work situation; and

a distribution control step of controlling distribution of the advertisement.

### Supplementary Note 10

A program causing a computer to execute:

a worker attribute acquisition step of acquiring a worker attribute indicating a worker attribute;

a work situation acquisition step of acquiring a work situation of the worker;

an advertisement determination step of determining an advertisement to be distributed to the worker based on the worker attribute and the work situation; and

a distribution control step of controlling distribution of the advertisement.

Some or all of the elements (for example, configurations and functions) that have been described in Supplementary Notes 2 to 8, which are dependent on Supplementary Note 1, may depend from Supplementary Notes 9 and 10 as well with dependency relationships similar to those of Supplementary Notes 2 to 8. Some or all of the elements that have been described in any supplementary note are applicable to various types of hardware, software, recording means for recording software, systems, and methods.

What is claimed is:

1. A distribution control system comprising:
at least one memory storing instructions; and
at least one processor configured to execute the instructions to:
acquire a worker attribute indicating a worker attribute;
acquire a work situation of the worker;
determine an advertisement to be distributed to the worker based on the worker attribute and the work situation; and
control distribution of the advertisement.

2. The distribution control system according to claim 1, wherein
the at least one processor is further configured to execute the instructions to determine a distribution timing including at least one of a distribution start timing and a distribution end timing of the advertisement based on the work situation, and distribute the advertisement based on the determined distribution timing.

3. The distribution control system according to claim 2, wherein
the at least one processor is further configured to execute the instructions to acquire a schedule of the worker, specify a viewable time zone indicating a time zone in which the worker can view the advertisement based on the acquired schedule, and determine the distribution timing based on the specified viewable time zone.

4. The distribution control system according to claim 3, wherein
the at least one processor is further configured to execute the instructions to specify a break time zone of the worker as the viewable time zone, determine a start time of the break time zone as the distribution start timing, and determine an end time of the break time zone as the distribution end timing.

5. The distribution control system according to claim 2, wherein
the at least one processor is further configured to execute the instructions to monitor whether the worker is in a safe situation based on at least one of a safety situation of the worker and the work situation, and determine the distribution timing in such a way as to prevent distribution of the advertisement in a case where the worker is not in the safe situation.

6. The distribution control system according to claim 2, wherein
the at least one processor is further configured to execute the instructions to control distribution of the advertisement based on a progress status of work in the worker or a work group, and make at least one of the distribution timing and an advertisement attribute indicating an attribute of the advertisement different between a case where a delay has occurred in the progress status and a case where no delay has occurred.

7. The distribution control system according to claim 1, wherein
the at least one processor is further configured to execute the instructions to set a reward to the worker according to a distribution status of the advertisement.

8. The distribution control system according to claim 1, wherein
the worker performs the work by wearing a glasses-type device for displaying a support image for supporting the work, and
the at least one processor is further configured to execute the instructions to distribute the advertisement to the glasses-type device.

9. A distribution control method comprising:
acquiring a worker attribute indicating a worker attribute;
acquiring a work situation of the worker;
determining an advertisement to be distributed to the worker based on the worker attribute and the work situation; and
controlling distribution of the advertisement.

10. A non-transitory computer-readable medium storing a program for causing a computer to execute:
acquiring a worker attribute indicating a worker attribute;
acquiring a work situation of the worker;
determining an advertisement to be distributed to the worker based on the worker attribute and the work situation; and
controlling distribution of the advertisement.
